(19) United States
(12) Patent Application Publication
(10) Pub. No.: US 2024/0052204 A1
(43) Pub. Date: Feb. 15, 2024

(54) ADHESIVE BONDING METHOD FOR AUTOMATED PROCESSES

(71) Applicant: SIKA TECHNOLOGY AG, Baar (CH)

(72) Inventors: Denise STORRER, Zürich (CH); Manuel BUCK, Gebenstorf (CH); Reto DOHNER, Zürich (CH); Matthias DICK, Zufikon (CH)

(73) Assignee: SIKA TECHNOLOGY AG, Baar (CH)

(21) Appl. No.: 18/271,067

(22) PCT Filed: Mar. 11, 2022
(86) PCT No.: PCT/EP2022/056403

§ 371 Date: Jul. 6, 2023

(30) Foreign Application Priority Data
Mar. 18, 2021 (EP) 21163424.1

(51) Int. Cl. C09J 5/02; C09J 4/06; C09J 133/06; B32B 37/12

(52) U.S. Cl. CPC C09J 5/02; C09J 4/06; C09J 133/066; B32B 37/1284; C09J 2433/00; C09J 2475/00; B32B 2037/1215; B32B 2037/1261; B32B 2310/0887; B32B 2310/0831

(57) ABSTRACT

A method for adhesively bonding two substrates, including the steps: (a) applying a liquid, radiation-curable primer composition onto the surface of a first substrate; (b) curing the liquid, radiation-curable primer composition by applying radiation with a suitable wavelength, intensity and temporal exposure such that the radiation-curable primer composition is cured into a solidified, coherent or interrupted layer adhering to the surface of the substrate; (c) optionally storing the primed substrate for a time of up to 6 months; (d) applying a curable adhesive composition onto the cured primer composition on the substrate; (e) joining a second substrate to the adhesive composition on the first substrate such that an adhesive bond is formed between the substrates, wherein the surface of the second substrate to be adhesively bonded is optionally pre-treated to improve adhesion before step (e) is performed; (f) curing the curable adhesive composition.

### TECHNICAL FIELD

The invention relates to a method for adhesively bonding two substrates using a primer and an adhesive.

### BACKGROUND OF THE INVENTION

Many industrial applications nowadays use high performance adhesives for structural bonding of parts in assembly processes. Compared to mechanical fixation methods, such as welding or screwing, adhesive bonding offers significant advantages in terms of process economy, versatility, and avoidance of mechanical weakening of the substrate, and it can be used on almost all bonding substrate materials. However, in order to ensure an optimal and permanent bonding performance between the adhesive and the substrate to be bonded, primers are commonly used to pretreat the substrate before the adhesive is applied. Primers are adhesion-promoting compositions that are applied on the substrate surface and after their curing and/or drying, create a thin, adherent layer on the surface. Due to their chemical composition often involving chemicals with different chemical reactivities, primers thus create a functional interlayer between the substrate and the adhesive applied thereon and often enable a covalent bonding of the adhesive via suitable chemical functional groups, such as hydroxyl- or amino groups, which would not be possible without them, e.g. on metallic or certain plastic substrates. This significantly improves the adhesive bond and prevents adhesion loss under demanding conditions, such as large temperature changes or excessive moisture. Such primers are commonly formulated as liquids containing the active, film-forming ingredients and large amounts of solvents, either organic solvents or less commonly water. Primers can be formulated as single-component compositions, where the active ingredients, such as epoxy resins, silanes, titanates, or isocyanates, react and cross-link under influence of moisture after application and once the solvent is evaporated, form the intended adhering interlayer on the substrate. Other primer compositions are applied as a two-component formulation, where chemically reactive ingredients, such as isocyanates and polyols or epoxy resins and amine hardeners, are separately stored and mixed just before or during application and subsequently produce an adhering interlayer on the substrate by crosslinking reactions with each other, while the solvent evaporates. For contemporary industrial assembly processes, such primers however have intrinsic disadvantages. They require high amounts of solvents in their composition to properly dissolve or dilute the active ingredients and to eventually form the required homogeneous, thinly dispersed adhering layer on the substrate. Solvents, especially those that evaporate fast enough for an efficient process, often are volatile organic compounds (VOC) with concerning EHS properties, therefore require costly safety measures and are detrimental to environmentally benign process workflows that are increasingly demanded in manufacturing industries. While it is possible to formulate primers based on water as solvent, which solves the VOC problem, water-based primers have other disadvantages, as water evaporates rather slowly and thus often cannot replace solvent-based primer compositions in fast industrial assembly processes. Additionally, water has limited wetting abilities on certain substrates. A further alternative are physical pretreatments, involving exposition of the substrate to plasma, flames, or lasers, which modify surfaces by applying energy and thus create specific reactive groups by partial oxidation. Such treatments also can be combined with a chemical coating process. However, these processes are comparably expensive and limited to certain suitable substrate materials, mostly plastics.

Thus, solvent-based primers are still the most used chemical adhesion pre-treatment in industrial processes, especially when coated or painted metallic substrate, or substrates with ceramic, glass or plastic surfaces are involved. As automatization is increasingly used in industrial assembly, for example in automotive manufacturing, also adhesive bonding operations are being automatized. However, especially when applied automatically, primers containing readily evaporating solvents tend to clog nozzles and tubes of such machinery, but also affect manual application materials such felts or foams due to premature solids formation. This is especially the case for reactive two-component primers that are mixed within an application apparatus, but it is observed also in single-compositions primers just due to solvent evaporation. These phenomena set strong limitations for the application process of such primers and render automatic application on highly optimized production lines challenging. Automatic spray applications of solvent-based primers have been implemented in industrial assembly processes, but it is often difficult to ensure process control and prevention of phenomena as described above, as this requires highly constant temperature and air humidity conditions. Furthermore, increasingly strict EHS regulations make it more and more difficult to implement spray application of solvent-based reactive primers, as the primer is usually applied as aerosol. This requires special measures to prevent workers from inhaling the aerosol, and furthermore many solvent's inherent potential for flammability or even explosion has to be addressed.

Therefore, nowadays still primers are often applied manually even in automated assembly lines with fully automatic adhesive application, but there is of course a demand to also automatize the pretreatment process, ideally without excessive safety measures associated to it.

However, apart from the above described limitations of currently used primers, there are further problems to be solved for efficient, automatically applicable pretreatment processes. Currently used pretreatments are often limited regarding their open times, i.e. the time after application and curing of the primer during which the adhesive can be applied thereon. First, there is a flash-off time required for the freshly applied primer to form a suitable, sufficiently dry layer on the substrate such that the adhesive can be applied thereon. During this, the evaporation of the solvents must be assured as well as a sufficient film-forming reaction of the reactive components. This limits the minimal open time for primers often to at least 5 minutes, which introduces an undesired waiting time until the application of the adhesive. Under less than ideal ambient conditions, including low temperature and high relative humidity, flash-off times can even be longer than expected. With some highly reactive compositions flash-off times of less than a minute are possible, but usually such products require an additional wipe-off process step to remove excess solvent, which is not suitable for automatic processes. On the other hand, it is often desired to have long open times and thus the possibility to apply the adhesive long after the primer was applied. In industrial assembly processes using pre-produced parts, it is often desired to prepare and prime a part for adhesive bonding already at the part-manufacturing facility and transport pretreated parts to another site for the adhesive bonding step. In these cases, a substrate pretreated with a primer must maintain the fully adhesion promotion effect for, e.g., at least 3 months. This is often difficult to achieve, as commonly employed primers often lose their adhesion promoter effect within at most a few weeks after application due to chemical and physical changes on their surface.

Thus, there is a demand for an adhesive bonding process that overcomes the described limitations of the current art and can be efficiently employed in fully automatic industrial assembly processes.

### SUMMARY OF THE INVENTION

The object of the present invention is to provide a method for adhesively bonding two substrates involving a primer and an adhesive, using a primer that does not require VOC solvents but still enables a fast, efficient process adapted to industrial assembly requirements and with the possibility to fully automatize the primer application, but without the risk of clogging nozzles and other application equipment. Furthermore, it is an object to provide such a method with the possibility to apply the adhesive within exceptionally short time after the primer application, i.e. within up to 5 minutes or less, yet simultaneously with the possibility to apply the adhesive up to several months after the primer was applied.

It was surprisingly found that by using a liquid, radiation-curable primer composition comprising at least one radiation-polymerizable monomer, at least one photosensitizer, photosynergist, photoinitiator, and/or catalyst suitable to induce or accelerate radiation curing of the radiation-polymerizable monomer, optionally radiation-curable polymers and furthermore optionally further additives selected from the group consisting of pigments, fillers, rheology modifiers, stabilizers, tougheners, and surfactants, and wherein the radiation-curable primer composition contains less than 5% by weight of solvents, in a method where this primer is applied onto the surface of a substrate and subsequently cured into a solidified, coherent or interrupted layer adhering to the surface of the substrate by applying radiation with a suitable wavelength, intensity and temporal exposure, a suitably pretreated substrate is obtained that can be adhesively bonded within less than 5 minutes or alternatively stored for a time of up to 6 months until a curable adhesive compositions is applied thereon and a second substrate is adhesively bonded therewith by joining it to the applied adhesive and curing the adhesive.

The subject of the present invention is a method as defined in claim 1.

One of the advantages of the method according to the present invention is that the primer contains very little and preferably no VOC solvents and is not reactive until activated by radiation. Apart from the EHS benefits including prevention of human exposure to VOC aerosols and vapors, the method according to the invention provides a much better suitability for automatized adhesive bonding processes than the state of the art, as the primer cannot clog during fluid transfer and application, yet after application can be immediately cured in a highly controllable manner and without the need to wait for solvent flash-off or moisture-induced chemical curing.

Thus, the primer application in the method of the present invention can be performed manually, e.g. by using felt or foam applicators, or in a fully automatic process, e.g. using robotic spray nozzles or inkjet applicators and without the need for mixing of the primer, as it is storage-stable until exposed to the curing radiation. The curing step can be controlled and performed automatically as well, e.g. by using an automatic directed radiation source that cures the primer immediately after application. This enables a highly efficient, fully automated process for adhesive bonding of geometrically complex objects. By using suitable application devices, such as robots, in some or all steps of the method, the present method offers unprecedented process efficiency and production output.

Another advantage of the method of the present invention is that not only can the primer application and curing step be significantly accelerated compared to traditional solvent-based or water-based primer applications, but due to the solventless approach using liquid, polymerizable monomers a denser primer film is obtained on the substrate surface that maintains its adhesion promoting effect for up to 6 months, or longer, if protected from dust or oil contamination. This allows for separately produced and transported assembly parts.

Other aspects of the present invention are presented in other independent claims. Preferred aspects of the invention are presented in the dependent claims.

### DETAILED DESCRIPTION OF THE INVENTION

The subject of the present invention is A method for adhesively bonding two substrates S1 and S2, comprising the steps:
a) applying a liquid, radiation-curable primer composition P onto the surface of substrate S1;
b) curing the liquid, radiation-curable primer composition P by applying radiation with a suitable wavelength, intensity and temporal exposure such that the radiation-curable primer composition P is cured into a solidified, coherent or interrupted layer adhering to the surface of substrate S1;
c) optionally storing the primed substrate S1 for a time of up to 6 months;
d) applying a curable adhesive composition A onto the cured primer composition P on substrate S1;
e) joining substrate S2 to the adhesive composition A on substrate S1 such that an adhesive bond is formed between substrate S1 and substrate S2, wherein the surface of substrate S2 to be adhesively bonded is optionally pre-treated to improve adhesion before step e) is performed;
f) curing the curable adhesive composition A;
wherein
said liquid, radiation-curable primer composition P comprises:
   at least one radiation-polymerizable monomer,
   at least one photosensitizer, photosynergist, photoinitiator, and/or catalyst suitable to induce or accelerate radiation curing of the radiation-polymerizable monomer;
   optionally at least one radiation-curable polymer;
   optionally further additives selected from the group consisting of pigments, fillers, rheology modifiers, stabilizers, tougheners, and surfactants;
      wherein the radiation-curable primer composition P contains less than 5% by weight of solvents, in relation to the whole primer composition P.

In the present document, the term “silane group” refers to a silyl group which is bonded to an organic radical or to an organosiloxane radical and has one to three, especially two or three, hydrolysable substituents on the silicon atom. Particularly useful hydrolysable substituents on the silicon atom are alkoxy groups. These silane groups are also referred to as “alkoxysilane groups”. Silane groups may also be present in partly or fully hydrolyzed form, for example as silanols. “Hydroxysilane”, “isocyanatosilane”, “am inosilane” and “mercaptosilane” refer respectively to organoalkoxysilanes having one or more hydroxyl, isocyanato, amino or mercapto groups on the organic radical in addition to the silane group. “Aminofunctional compound” refers to a compound which contains an amino group.

Substance names beginning with “poly”, such as polyol, polyether, or polyisocyanate, refer to substances containing, in a formal sense, two or more of the functional groups that occur in their name per molecule.

The term “organic polymer” encompasses a collective of macromolecules that are chemically homogeneous but differ in relation to degree of polymerization, molar mass and chain length, which has been prepared by a poly reaction (polymerization, polyaddition, polycondensation) and has a majority of carbon atoms in the polymer backbone, and reaction products of such a collective of macromolecules. Polymers having a polyorganosiloxane backbone (commonly referred to as “silicones”) are not organic polymers in the context of the present document.

“Molecular weight” is understood in the present document to mean the molar mass (in grams per mole) of a molecule or part of a molecule, also referred to as “radical”. “Average molecular weight” is understood to mean the number-average Mₙ of an oligomeric or polymeric mixture of molecules or radicals, which is typically determined by means of gel permeation chromatography (GPC) against polystyrene as standard.

“Storage-stable” or “storable” refers to a substance or composition when it can be stored at room temperature in a suitable container over a prolonged period, typically at least 3 months up to 6 months or more, without any change in its application or use properties, especially in the viscosity and crosslinking rate, to a degree of relevance for the use thereof as a result of the storage.

“Room temperature” refers to a temperature of about 23° C.

The term “crosslinked” designates a polymer matrix, in which the polymer chains are inter-connected by a plurality of covalent bonds that are stable mechanically and thermally. Other possible forms of crosslinked polymers such as physically crosslinked polymers are not regarded as “crosslinked” in the context of the present disclosure. The terms “cured” and “vulcanized” may be used interchangeably with the term “crosslinked”.

The present document defines “volatile organic compounds” or abbreviated “VOC” as organic compounds that are liquids having a boiling point of between 50° C. and 250° C. under standard pressure (1013 mbar) and/or a vapor pressure of at least 0.1 mbar at 20° C. Furthermore, volatile organic compounds within the definition of this document do not possess functional groups that make these compounds radiation-polymerizable with the radiation-polymerizable monomer as defined further below. In particular, volatile organic compounds within the definition of this document do not possess ethylenically unsaturated carboxylic acid groups such as (meth)acrylic acid groups, ethylenically unsaturated carboxylic ester groups such as alkyl(meth)acrylate groups, ethylenically unsaturated amide or nitrile groups, ethylene or vinyl groups, epoxy or glycidyl groups, or thiol groups. In particular all common organic solvents employed in solvent-based primer compositions are considered volatile organic compounds. For example, ethanol, ethyl acetate, hexane, butanone, or acetone are VOCs within this definition.

Substrates S1 and S2

Suitable substrates S1 and/or S2 that can be adhesively bonded using the method according to the present invention include:
glass, glass ceramic, enamel, concrete, mortar, brick, tile, gypsum and natural rocks such as limestone, granite or marble;
metals and alloys such as aluminum, iron, steel and nonferrous metals, and also surface-finished metals and alloys such as galvanized or chromed metals or surface coated metals, such as Kynar® or Duranar®-coated aluminum, cathodic dip coated (E-coated) metals, oxidized metals, powder-, resin-, or polymer-coated metals;
leather, textiles, paper, wood, woodbase materials bonded with resins, for example phenolic, melamine or epoxy resins, resin-textile composites and further polymer composites, such as resin-, glass- or carbon-fiber composites;
plastics such as polyvinyl chloride (rigid and flexible PVC), acrylonitrile-butadiene-styrene copolymers (ABS), polycarbonate (PC), polyamide (PA), polyesters, poly(methyl methacrylate) (PMMA), epoxy resins, polyurethanes (PUR), polyoxymethylene (POM), ethylene/propylene/diene terpolymers (EPDM), and also fiber-reinforced plastics such as carbon fiber-reinforced plastics (CFP), glass fiber-reinforced plastics (GFP) and sheet molding compounds (SMC), where the plastics may optionally have been surface-treated by means of plasma, corona or flames;
coated substrates such as powder-coated metals or coated plastics or composites;
paints, lacquers, or varnishes, especially automotive topcoats.

The S1 and/or S2 to be adhesively bonded by the method according to the present invention is preferably selected from the list consisting of: glass, glass ceramic, ceramic frits, concrete, mortar, brick, tile, gypsum, natural stone, metals and alloys, oxidized metals, powder-, resin-, or polymer-coated metals, textiles, wood, wood-resin composites, resin-textile composites, resin-glass- or carbon-fiber composites, polyvinyl chloride (PVC), acrylonitrile-butadiene-styrene copolymers (ABS), polycarbonate (PC), polyamide (PA), polyesters, poly(methyl methacrylate) (PMMA), epoxy resins, paints, varnishes, and coated or painted substrates.

One advantage of the present invention is that especially plastic substrates sensitive to stress-cracking, such as polystyrene, polycarbonate, and PMMA, can be adhesively bonded by the method according to the invention without damaging these substrates. In other adhesive bonding processes that employ solvent-based primers, stress-cracking due to migration effects is common in these plastic substrates. Water-based primers on the other hand often have poor wetting performance on plastic substrates and long flash-off times after application due to slow evaporation.

Thus, especially for high throughput industrial assembly processes, the method of the present invention allows for highly optimized adhesive bonding processes without intermittent waiting steps and without problems arising from solvents, such EHS concerns and possible plastic substrate damaging.

If required, the substrates S1 and/or S2 to be adhesively bonded by the method according to the present invention can be additionally pretreated prior to the application of the primer composition P and subsequently the adhesive composition A, especially by physical cleaning methods, such as sanding, de-greasing, wiping, or brushing.

In general, it is not required to pre-treat the surfaces prior to application of the primer composition P, in particular not by chemically reactive methods. The primer composition P shows an excellent adhesion profile on a large variety of unprimed, non-pretreated, and even uncleaned materials.

However, it may be advantageous to de-grease, clean, or brush the substrates before applying the primer composition P. This is normally only required when the substrates are visibly dirty or layered with dust, but may be advantageous in any case, e.g. to remove process oils or other surface contaminants. It may be advantageous to use an alcohol or mild solvent to de-grease the surfaces after mechanical removal of any particulate matter possibly present.

Primer composition P

The method according to the invention includes the application of a liquid, radiation-curable primer composition P.

The term “liquid” means that the primer composition must be in liquid, free-flowing state at 23° C., having a viscosity low enough to be suitable as a primer and applicable on substrate surfaces in thin layers with a thickness of less than 1 mm without applying pressure. In preferred embodiments, the primer composition P has a viscosity in the range of between 1 and 50 mPa·s, in particular between 2 and 35 mPa·s, preferably between 5 and 20 mPa·s, measured at 23° C. and preferably using a plate-plate viscosimeter.

The liquid, radiation-curable primer composition P comprises:
at least one radiation-polymerizable monomer,
at least one photosensitizer, photosynergist, photoinitiator, and/or catalyst suitable to induce or accelerate radiation curing of the radiation-polymerizable monomer;
optionally at least one radiation-curable polymer;
optionally further additives selected from the group consisting of pigments, fillers, rheology modifiers, stabilizers, tougheners, and surfactants;
   wherein the radiation-curable primer composition P contains less than 5% by weight of solvents, in relation to the whole primer composition P.

Primer composition P comprises at least one radiation-polymerizable monomer.

The term “radiation-polymerizable monomer” encompasses all non-polymerized substances with a defined, discrete molecular weight of less than 1000 g/mol which due to their molecular structure and/or functional groups can be crosslinked or polymerized by exposure to a suitable radiation, optionally by involving photoreactive additives, and by this process form macromolecular chains and/or networks wherein a multitude of said monomers are incorporated.

Preferably, the radiation-polymerizable monomer is a mixture of structurally different monomers that however share certain chemical functionalities so they can be reacted with each other under suitable radiation curing conditions. These shared chemical functionalities may include overall identical chemical functionalities such as (meth)acrylate groups, or chemically different functionalities that however can react under the same conditions with each other, such as (meth)acrylate groups and thiol groups under radical-induced curing conditions.

The at least one radiation-polymerizable monomer is commonly the main ingredient of the primer composition P. Thus, in order to obtain a liquid primer composition P, it is preferred to use monomers that are liquid under standard pressure. However, it is possible to admix high molecular and/or solid constituents with such liquid monomers as long as the final formulation is a liquid that can be applied in the method according to the invention.

In a preferred embodiment, the at least one radiation-polymerizable monomer in primer composition P comprises or mainly consists of ethylenically unsaturated carboxylic acid ester monomers, in particular acrylic monomers, and optionally thiol-functional monomers, such as mercaptosilanes.

The term “acrylic monomer” encompasses all polymerizable molecules with at least one polymerizable (meth)acrylic acid, (meth)acrylate, (meth)acrylnitril or (meth)acrylamide group.

It is possible and may be advantageous to use co-polymerizable non-acrylic monomers with the acrylic monomers, such as styrene, alpha-methylstyrene, substituted styrene, vinyl esters, vinyl ethers, and N-vinyl-2-pyrrolidone. However, in some embodiments it is preferred that at least the major part of the radiation-polymerizable monomer within the primer composition P consists of acrylic monomers.

In the same or another preferred embodiment, the at least one radiation-polymerizable monomer in primer composition P comprises epoxy-functional monomers.

Suitable and preferred radiation-polymerizable monomers for use in primer composition P include monofunctional and multifunctional (di-, tri- or higher-functional) monomers. By mono-, di-, tri- and higher-functional monomers is meant compounds having, respectively, one, two, three or more functional groups (such as unsaturated carbon-carbon groups, in particular (meth)acrylate groups and/or epoxy groups) which are polymerizable by radiation, especially (but not exclusively) by ultraviolet light.

Monofunctional polymerizable monomers suitable as radiation-polymerizable monomers in primer composition P include, for example, styrene, alpha-methylstyrene, substituted styrene, vinyl esters, vinyl ethers, N-vinyl-2-pyrrolidone, (meth)acrylamide, N-substituted (meth)acrylamide, nonylphenol ethoxylate (meth)acrylate, 2-(2-ethoxyethoxy)ethyl(meth)acrylate, β-carboxyethyl(meth)acrylate, cycloaliphatic epoxide, α-epoxide, 2-hydroxyethyl(meth)acrylate, (meth)acrylonitrile, maleic anhydride, methyl(meth)acrylate, octyl(meth)acrylate, isononyl(meth)acrylate, 2-ethylhexyl (meth)acrylate, lauryl(meth)acrylate, isobutyl(meth)acrylate, isodecyl (meth)acrylate, dodecyl(meth)acrylate, n-butyl(meth)acrylate, hexyl (meth)acrylate, isooctyl(meth)acrylate, isobornyl(meth)acrylate, N-vinylcaprolactam, stearyl(meth)acrylate, hydroxy functional caprolactone ester, hydroxyethyl(meth)acrylate, hydroxymethyl(meth)acrylate, hydroxypropyl (meth)acrylate, hydroxyisopropyl(meth)acrylate, hydroxybutyl(meth)acrylate, hydroxyisobutyl(meth)acrylate, tetrahydrofurfuryl(meth)acrylate, combinations of these, and the like. The use of “(meth)acrylate” is intended to refer both to “acrylate” and “methacrylate” throughout this document.

Multifunctional monomers suitable as radiation-polymerizable monomers in primer composition P include, for example, pentaerythritol triacrylate, hexanediol diacrylate, dipropyleneglycol diacrylate, tri(propylene glycol) triacrylate, neopentylglycol diacrylate, bis(pentaerythritol) hexa-acrylate, and the acrylate esters of ethoxylated or propoxylated glycols and polyols, for example, propoxylated neopentyl glycol diacrylate and ethoxylated trimethylolpropane triacrylate. Also included are triethylene glycol divinyl ether, diethylene glycol divinyl ether, 1,4-cyclohexanedimethanol divinyl ether and ethylene glycol monovinyl ether.

Multifunctional radiation-polymerizable monomers mainly act as crosslinkers within the radiation-polymerizable monomer composition. They are advantageous since they allow for a certain degree of cross-linking in the polymerized, radiation-cured primer composition, which increases mechanical stability of the cured primer layer on the surface of the primed substrate.

Higher amounts of multifunctional radiation-polymerizable monomers within the mixture of radiation-polymerizable monomers in primer P lead to higher cross-linking in the cured, polymerized primer. However, too high amounts of multifunctional monomers increase the brittleness of the cured primer composition and may be disadvantageous. Generally, multifunctional radiation-polymerizable monomers with higher functionality, for example 4 or 5, lead to higher and denser cross-linking than those with lower functionality, for example 2 or 3.

Preferably, the amount of multifunctional radiation-polymerizable monomer within primer composition P is in the range of between 0% and 25% by weight, in particular between 0.5% and 20% by weight, especially between 1% and 10% by weight, based on the primer composition P.

Preferably, the amount of multifunctional radiation-polymerizable monomer within all radiation-polymerizable monomers is in the range of between 0% and 50% by weight, in particular between 1% and 25% by weight, especially between 5% and 15% by weight, based on all radiation-polymerizable monomers.

Suitable examples of preferred acrylic monomers to be used as radiation-polymerizable monomers in primer composition P include, but are not limited to, methyl acrylate, methyl methacrylate, ethyl acrylate, ethyl methacrylate, butyl acrylate, butyl methacrylate, isobutyl acrylate, isobutyl methacrylate, n-hexyl acrylate, n-hexyl methacrylate, ethylhexyl acrylate, ethylhexyl methacrylate, n-heptyl acrylate, n-heptyl methacrylate, 2-methylheptyl(meth)acrylate, octyl acrylate, octyl methacrylate, isooctyl(meth)acrylate, n-nonyl(meth)acrylate, iso-nonyl(meth)acrylate, decyl(meth)acrylate, isodecyl acrylate, isodecyl methacrylate, dodecyl(meth)acrylate, isobornyl(meth)acrylate, lauryl methacrylate, lauryl acrylate, tridecyl acrylate, tridecyl methacrylate, stearyl acrylate, stearyl methacrylate, glycidyl methacrylate, alkyl crotonates, vinyl acetate, di-n-butyl maleate, di-octylmaleate, acetoacetoxyethyl methacrylate, acetoacetoxyethyl acrylate, acetoacetoxypropyl methacrylate, acetoacetoxypropyl acrylate, diacetone acrylamide, acrylamide, methacrylamide, hydroxyethyl methacrylate, hydroxyethyl acrylate, allyl methacrylate, tetrahydrofurfuryl methacrylate, tetrahydrofurfuryl acrylate, cyclohexyl methacrylate, cyclohexyl acrylate, n-hexyl acrylate, n-hexyl methacrylate, 2-ethoxyethyl acrylate, 2-ethoxyethyl methacrylate, isodecyl methacrylate, isodecyl acrylate, 2-methoxy acrylate, 2-methoxy methacrylate, 2-(2-ethoxyethoxy)ethylacrylate, 2-phenoxyethyl acrylate, 2-phenoxyethyl methacrylate, isobornyl acrylate, isobornyl methacrylate, caprolactone acrylate, caprolactone methacrylate, benzyl acrylate, benzyl methacrylate, sodium 1-allyloxy-2-hydroylpropyl sulfonate, acrylonitrile, and the like.

Two or more of the acrylic monomers may be used in combination as radiation-polymerizable monomers in primer composition P. Preferably, the acrylic monomer has up to about 20 carbon atoms, such as, but not limited to, 2-ethylhexyl acrylate, methyl methacrylate, methyl acrylate, methyl methacrylate, ethyl acrylate, ethyl methacrylate, butyl acrylate, butyl methacrylate, isobutyl acrylate, isobutyl methacrylate, n-hexyl acrylate, n-hexyl methacrylate, ethylhexyl acrylate, ethylhexyl methacrylate, n-heptyl acrylate, n-heptyl methacrylate, 2-methylheptyl(meth)acrylate, octyl acrylate, octyl methacrylate, isooctyl(meth)acrylate, n-nonyl(meth)acrylate, iso-nonyl(meth)acrylate, decyl(meth)acrylate, isodecyl acrylate, isodecyl methacrylate, dodecyl(meth)acrylate, isobornyl(meth)acrylate, hydroxyethyl methacrylate, hydroxyethyl acrylate, allyl methacrylate, cyclohexyl methacrylate, cyclohexyl acrylate, n-hexyl acrylate, n-hexyl methacrylate, isobornyl acrylate, isobornyl methacrylate, and the like. Most preferably, the acrylate monomers are tridecyl acrylate and 2-ethylhexyl acrylate.

In a preferred embodiment, said radiation-polymerizable monomer comprised in said liquid, radiation-curable primer composition P comprises or consists of acrylic monomers in an amount of at least 40% by weight, preferably at least 50% by weight, in relation to the whole primer composition P and optionally thiol-functional adhesion-promoting monomers.

In another preferred embodiment, said liquid, radiation-curable primer composition P consists of (meth)acrylate monomers and optionally thiol-functional adhesion-promoting monomers, and optionally at least one radiation-curable polymer, and said at least one photosensitizer, photosynergist, photoinitiator, and/or catalyst.

Preferably, the radiation-polymerizable monomers in primer composition P comprise adhesion-promoting monomers having functional groups that can react or at least interact with the curable adhesive composition A and/or the surface of substrate S1.

Preferred radiation-polymerizable monomers with adhesion-promoting properties include, for example, (meth)acrylic acids, (meth)acrylic phosphate esters, silanes such as 3-mercaptopropyltrimethoxysilane, (3-(meth)acryloyloxypropyl)trimethoxysilane and 3-glycidyloxypropyltrimethoxysilane or the respective triethoxysilanes, or mixtures of said silanes, and/or Zn di(meth)acrylates.

Adhesion-promoting monomers should preferably be selected suitable for the specific substrate S1 and curable adhesive A.

For example, a useful adhesion-promoting monomer in acrylate-based compositions of primer P are (meth)acryloxyalkylsilanes or (meth)acryl-functional silanes having hydrolysable alkoxysilane groups. These compounds are polymerized into the acrylic network, and their silane functionality allows improved adhesion on glass or silicate substrates. Equally, such silanes improve the adhesion of adhesives based on silicones or silane-terminated polymers, as they can react via silane condensation with the polymer matrix of the adhesive and create covalent bonds. Further suitable in this sense are mercaptosilanes. Similarly, for polyurethane-based adhesives A, polymerizable amino-functional monomers or hydroxy-functional monomers, such as for example hydroxyethylacrylate in primer composition P give the possibility for covalent bonds with the isocyanate groups of the polyurethane polymers in adhesive A.

Epoxy-functional radiation-polymerizable monomers, such as for example glycidylmethacrylate in primer composition P are able to covalently bond with epoxy-based adhesives A, and additionally improve adhesion of the primer composition P on metallic substrates S1.

Adhesion on some metallic substrates S1 can also be improved by acetoacetoxyalkyl acrylates.

For low surface energy substrates S1 and/or curable adhesives A with low polarity, for example certain silicones, incorporation of long chain alkyl monomers such as dodecyl(meth)acrylate improves the adhesion and wetting capabilities of primer composition P to the substrate or the adhesive, respectively.

Further suitable as adhesion-promoting radiation-polymerizable monomers are acrylate monomers with phosphoric acid ester functionalities such as (meth)acrylic phosphate esters and zinc di(meth)acrylates.

Also, non-esterified monomers such as acrylic acid, methacrylic acid, itaconic acid, and the like have strong adhesion-promoting properties due to their anionic acid functionalities when deprotonated, which allows for strong interactions with metallic or inorganic substrates. Therefore, such acid-functional monomers are considered as adhesion-promoting radiation-polymerizable monomers in this document.

These adhesion-promoting radiation-polymerizable monomers can be included in any amount, as long as the polymerization proceeds properly and the general properties, such as viscosity of primer composition P remain within the intended ranges.

Preferably, the amount of adhesion-promoting radiation-polymerizable monomer within primer composition P is in the range of between 0% and 20% by weight, in particular between 1% and 10% by weight, especially between 2% and 5% by weight, based on the primer composition P.

Primer composition P may furthermore preferably comprise at least one radiation-curable polymer. The term “radiation-curable polymer” is defined as a polymeric compound having a molecular weight distribution and thus an average molecular weight instead of a discretely defined one, and having functional groups that identical to or at least reactive with the functional groups of the radiation-polymerizable monomers under radiation-induced curing conditions.

Inclusion of a radiation-curable polymer in primer composition P has the advantage of better wettability of the primer on certain substrates, potentially improving the adhesion.

Furthermore, a radiation-curable polymer in primer composition P may improve the toughness of the cured primer film, which may prevent crack formation in the cured primer and/or adhesion loss in case of thermal volume changes of the substrate (dilation or contraction) or strong mechanical impacts and vibrations.

Preferably, the at least one radiation-curable polymer has a number-average molecular weight Mn in the range of 200 g/mol to 5000 g/mol, preferably from 250 g/mol to 3000 g/mol, in particular from 300 g/mol to 2500 g/mol, measured by GPC against a polystyrene standard.

Preferred radiation-curable polymers include (meth)acrylic functionalized butadiene, isoprene-based polymers or block-copolymers, (meth)acrylic functionalized polyethers, and polyurethane-(meth)acrylate polymers.

Preferred are polyurethane-(meth)acrylate polymers, in particular those that are obtainable through the reaction of a polyethylene polyol or polypropylene polyol, a diisocyanate and a hydroxy functionalized ethylenically unsaturated monomer, and mixtures thereof.

Preferred (meth)acrylic functionalized polyethers include polypropyleneglycol monoacrylate, polypropyleneglycol monomethacrylate, polyethyleneglycol (meth)acrylate, polypropyleneglycol (meth)acrylate, and such polyethers with mixed polyethylene and polypropylene backbones.

The amount of radiation-curable polymers within primer composition P may be relatively high in order to maximize the above described beneficial properties in the cured primer composition, as long as the overall properties such as viscosity remain suitable for application as a primer.

Preferably, the amount of radiation-curable polymers within primer composition P is in the range of between 0% and 45% by weight, in particular between 5% and 40% by weight, especially between 10% and 35% by weight, based on the primer composition P.

The radiation-curable primer composition P contains less than 5% by weight, preferably less that 2.5% by weight, in particular less than 1% by weight of solvents, in relation to the whole primer composition P.

The term “solvent” includes all liquid substances that are used to dissolve or at least disperse the reactive, film-forming ingredients of the primer composition P, but that are not reactive with said reactive, film-forming ingredients in a way that inhibits the curing of the primer composition. Water, for example, is solvent used in water-based primer compositions. In solvent-based primer compositions, organic solvents are used, in particular VOC solvents.

Preferably, the primer composition P does not contain analytically detectable quantities of solvents, in particular of solvents that are VOC.

In a preferred embodiment of the method according to the present invention, said liquid, radiation-curable primer composition P consists of (meth)acrylate monomers, and optionally thiol-functional adhesion-promoting monomers, and optionally at least one radiation-curable polymer, and said at least one photosensitizer, photosynergist, photoinitiator, and/or catalyst.

Primer composition P optionally comprises further additives selected from the group consisting of pigments, fillers, rheology modifiers, stabilizers, tougheners, and surfactants. Such additives are known in the field of acrylic compositions. For example, tougheners may include core-shell particles or non-reactive rubbery polymers or resins. The above additives are generally understood to not have chemical functionalities that allow them to cross-link with the radiation-polymerizable monomers contained in primer compositions P. However, it is possible that some reactions may occur, but it is preferred that these additives do not have chemical groups that can be readily incorporated into the cross-linking polymer formed by curing the radiation-polymerizable monomer, such as (meth)acrylate groups in embodiments where an acrylic composition is used as primer composition P.

Additives as detailed above may preferably be present in radiation-curable primer composition P with amounts of up to 25% by weight, based on the total radiation-curable primer composition P.

The liquid, radiation-curable primer composition P comprises at least one photosensitizer, photosynergist, photoinitiator, and/or catalyst suitable to induce or accelerate radiation curing of the radiation-polymerizable monomer. This includes all substances that are able to initiate, accelerate, and/or control the intended radiation-induced curing mechanism of the radiation-polymerizable compounds contained in primer composition P. Such additives are normally required in radiation-curable compositions and are well known in the field ensure a proper and controlled rapid curing of radiation-curable compounds under defined radiation exposure. The photosensitizer, photosynergist, photoinitiator, and/or catalyst can be selected suitably for the intended curing radiation wavelength and intensity such that it is either activated to induce, for example, a radical polymerization process, or otherwise supports the curing process, e.g. by formation of reactive intermediates. Since these additives are only activated by a defined radiation but upon activation establish a highly efficient curing reaction, it is possible to use radiation-curable monomers of lower intrinsic reactivity in the primer composition P, which increases the storage stability of the primer composition and prevents premature polymerization under influence, e.g. of sunlight or air.

A photoinitiator is advantageous for initiating the curing of the radiation-polymerizable monomer and polymer, if present in the composition. In some embodiments, a photoinitiator that absorbs radiation, for example ultra-violet (UV) light radiation, to initiate curing of the radiation-curable components of the primer composition P may be used. UV radiation is the preferred radiation used in the method of the present invention. Therefore, in preferred embodiments, the radiation-curable primer composition P is an ultra-violet radiation curable primer composition.

Suitable photoinitiators include, but are not limited to, aldehydes, such as benzaldehyde, acetaldehyde, and their substituted derivatives; ketones, such as, acetophenone, benzophenone and their substituted derivatives; quinines, such as, benzoquinones, anthraquinone and their substituted derivatives; thioxanthones, such as, 2-isopropylthioxanthone and 2-dodecylthioxanthone; and certain chromophore-substituted vinyl halomethyl-sym-triazines, such as, 2-4-bis-(trichloromethyl)-6-(3′,4′-dimethoxyphenyl)-sym-triazine.

Specific examples of suitable photoinitiators include 2,4,6-trimethylbenzoyldiphenylphosphine oxide (available as BASF LUCIRIN® TPO); 2,4,6-trimethylbenzoylethoxyphenylphosphine oxide (available as BASF LUCIRIN® TPO-L); bis(2,4,6-trimethylbenzoyl)-phenyl-phosphine oxide (available as Ciba IRGACURE® 819) and other acyl phosphines; 2-methyl-1-(4-methylthio)phenyl-2-(4-morphorlinyl)-1-propanone (available as Ciba IRGACURE® 907) and 1-(4-(2-hydroxyethoxy)phenyl)-2-hydroxy-2-methylpropan-1-one (available as Ciba IRGACURE® 2959); 2-benzyl 2-dimethylamino 1-(4-morpholinophenyl)butanone-1 (available as Ciba IRGACURE® 369); 2-hydroxy-1-(4-(4-(2-hydroxy-2-methylpropionyl)-benzyl)-phenyl)-2-methylpropan-1-one (available as Ciba IRGACURE® 127); 2-dimethylamino-2-(4-methylbenzyl)-1-(4-morpholin-4-ylphenyl)-butanone (available as Ciba IRGACURE® 379); titanocenes; isopropylthioxanthone; 1-hydroxy-cyclohexylphenylketone; benzophenone; 2,4,6-trimethylbenzophenone; 4-methylbenzophenone; diphenyl-(2,4,6-trimethylbenzoyl)phosphine oxide; 2,4,6-trimethylbenzoylphenylphosphinic acid ethyl ester; oligo(2-hydroxy-2-methyl-1-(4-(1-methylvinyl)phenyl)propanone); 2-hydroxy-2-methyl-1-phenyl-1-propanone; benzyl-dimethylketal; and mixtures thereof.

Examples of radical photoinitiators include 2,2-dimethyl-2-hydroxy-acetophenone; 1-hydroxy-1-cyclohexyl-phenyl ketone; 2,2-dimethoxy-2-phenylacetophenone; 2,4,6-trimethylbenzyl-diphenyl-phosphine oxide; Benzophenone; blends of bis(2,6-dimethoxybenzoyl)-2,4,4-trimethyl pentyl phosphine oxide and 1-phenyl-2-hydroxy-2-methyl propanone; blends of bis(2,6-dimethoxybenzoyl)-2,4,4-trimethyl pentyl phosphine oxide and 1-hydroxycyclohexyl-phenyl ketone; bis(2,4,6-trimethylbenzoyl)phenylphosphine oxide; and camphorquinone. Examples of cationic photoinitiators include iodonium and sulfonium salts. Preferred photoinitiators include 2-benzyl-2-dimethylamino-1-(4-morpholinophenyl)-butan 1-one, and/or 2-methyl-1-(4-(methylthio)phenyl)-2-morpholino-propan-1-one. A preferred photoinitiator is Bis(2,4,6-trimethylbenzoyl)-phenyl-phosphine oxide.

This list is not exhaustive, and any known photoinitiator that initiates the free-radical reaction of the radiation-curable compounds within primer composition P upon exposure to a desired wavelength of radiation such as UV light can be used without limitation.

The photoinitiator may absorb radiation of, for example, about 200 to about 420 nanometers wavelengths in order to initiate curing, although use of initiators that absorb at longer wavelengths, such as the titanocenes that may absorb up to 560 nanometers, can also be used without restriction.

The photoinitiator can be present in any suitable or desired amount. In some embodiments, the total amount of photoinitiator included in the primer composition P may preferably be from about 0.5 to about 15 percent by weight, or from about 1 to about 10 percent by weight, based on the total weight of the primer composition P.

In other preferred embodiments, the amount of photoinitiator is preferably within a range of about 0.05% to about 6% by weight based on the weight of the primer composition P, preferably about 0.1% to about 4% by weight of the primer composition P, and more preferably 0.5% to 2.5% by weight of the primer composition P.

Suitable are also synergists, in particular amine synergists, which are described as co-initiators that donate a hydrogen atom to a photoinitiator and thereby form a radical species that initiates polymerization (amine synergists can also consume oxygen dissolved in the composition or from the ambient air—as oxygen inhibits free-radical polymerization its consumption increases the speed of polymerization), for example such as ethyl-4-dimethylaminobenzoate and 2-ethylhexyl-4-dimethylaminobenzoate.

Examples of photoactivators and photosynergists include ethyl-4-(dimethylamino)benzoate, N-methyldiethanolamine and 2-ethylhexyidimethylaminobenzoate. Such materials will generally be required only for free-radical curing.

1-chloro-4-propoxythioxanthone and isopropyl thioxanthone (mixture of 2- and 4-isomers) have been used as sensitizers for α-amino acetophenones.

In one embodiment, the primer composition P comprises two or all three of a photosensitizer, a photosynergist and a photoinitiator, preferably at least a photoinitiator and a photosynergist.

A preferred photosensitizer is isopropyl thioxanthone.

A preferred photosynergist is ethyl-4-(dimethylamino)benzoate and/or amine modified polyether acrylate oligomers, such as Ebercryl® LED 03 (Allnex). Preferred photoinitiators included either one or several of 2-methyl-1-[4-methylthio)phenyl]-2-(4-morpholinyl)-1-propanone and/or 2-benzyl-2-(dimethylamino)-1-[4-(4-morpholinyl)phenyl]-1-butanone and/or Bis(2,4,6-trimethylbenzoyl)-phenyl-phosphine oxide.

In an especially preferred embodiment of the method according to the present invention, said liquid, radiation-curable primer composition P comprises or consists of:
between 40% by weight and 70% by weight, preferably between 45% by weight and 60% by weight, based on the total primer composition P, of said radiation-polymerizable monomers, in particular (meth)acrylate monomers and optionally thiol-functional adhesion-promoting monomers, and;
between 20% by weight and 40% by weight, preferably between 25% by weight and 35% by weight, based on the total primer composition P, of said at least one radiation-curable polymer;
between 1% by weight and 25% by weight, preferably between 5% by weight and 20% by weight, based on the total primer composition P, of said at least one photosensitizer, photosynergist, photoinitiator, and/or catalyst.

Preferably, in this embodiment, said radiation-polymerizable monomers, in particular (meth)acrylate monomers comprise:
between 5% by weight and 20% by weight, preferably between 7.5% by weight and 15% by weight, based on the total of all radiation-polymerizable monomers, in particular (meth)acrylate monomers, of multifunctional radiation-polymerizable monomers, in particular multifunctional (meth)acrylate monomers;
between 1% by weight and 10% by weight, preferably between 2.5% by weight and 7.5% by weight, based on the total of all radiation-polymerizable monomers, in particular (meth)acrylate monomers, of adhesion-promoting radiation-polymerizable monomers, in particular adhesion-promoting (meth)acrylate monomers and/or adhesion-promoting organosilanes.

The term “radiation” means all forms of radiation capable of curing the radiation-curable primer composition P including, but not limited to, ultraviolet light, electron beam, gamma ray, and X-ray. The amount of exposure to be used in the method of this invention is that which is sufficient to cause the radiation-curable composition to cure. The term “cure” refers to both crosslinking and curing. “Crosslinking” is defined as the formation of chemical or physical interactions between polymer chains. The term “curing” is more broadly defined than the term “crosslinking” and includes the total polymerization process from initiation of the reaction to when the radiation-curable primer composition P is fully cured into a solid adhering layer on the substrate. Therefore, the term “curing” as used in this application includes the polymerization of radiation-curable compositions as well as the crosslinking of radiation-curable compositions with suitable included crosslinkers, such as multifunctional acrylates.

Preferably, the radiation used in step b) of the method according to the present invention is selected from the group consisting of ultraviolet light, electron beams, gamma rays and X-rays.

More preferably, said radiation is ultraviolet light having an effective ultraviolet wavelength from 100 nm to 500 nm, or said radiation is an electron beam applied in an amount ranging from 10′000 Gy to 300′000 Gy.

Most preferred in the method according to the present invention is UV light, which may also contain parts of the visible light spectrum. This radiation can be sourced and installed in an inexpensive manner, is highly efficient for curing especially primer compositions P containing acrylic radiation-polymerizable monomers, and it is comparably safe to use.

In especially preferred embodiments, when UV light is utilized to cure the radiation-curable primer composition P, the effective ultraviolet wavelength may include for example UV-A, UV-B, and/or UV-C light as well as parts of the visible light spectrum. Suitable such radiation ranges in some embodiments from about 100 nm to about 400 nm, preferably from 100 nm to 280 nm, and in other embodiments from about 200 nm to about 500 nm, preferably from 300 nm to 450 nm.

Preferably, the used UV radiation ranges from about 300 nm to about 500 nm, preferably from 350 nm to 450 nm. This wavelength is particularly suitable for an efficient radiation curing of primer compositions P containing acrylic radiation-polymerizable monomer, and, due to the wavelength range not including high energy UV-C radiation, the associated health risk for accidentally exposed workers is lower.

When electron beam radiation is used, the amount to be used is that which is sufficient to effect radiation curing of the radiation-polymerizable compounds in primer composition P. Generally, a suitable amount of electron beam radiation ranges from about 10′000 Gy (Gray, corresponding to J/kg) to about 300′000 Gy, preferably from about 10′000 Gy to about 200′000 Gy, more preferably, from 20′000 Gy to 100′000 Gy. Suitable processes for curing with electron beam radiation can, for example, be found in U.S. Pat. No. 4,533,566. Electron beam radiation can be obtained from any source known in the art. Examples of sources include, but are not limited to, an atomic pile, a resonant transformer accelerator, a Van de Graaf electron accelerator, a Linac electron accelerator, a betatron, a synchrotron, a cyclotron, or the like.

Exposure of the applied primer composition P in the method according to the present invention may be effected in any suitable way that results in a sufficient radiation exposure to induce curing of the applied primer composition P. Specifically, this can be done either by moving the radiation source while the primer-coated substrate is stationary, e.g. by using an industrial robot, or by moving the primer-coated substrate past the radiation source, e.g by using a conveyor belt.

In preferred embodiments wherein the used radiation is ultraviolet light, the irradiation time employed to cure said liquid, radiation-curable primer composition P ranges between 1 second and 120 seconds, preferably between 2 seconds and 90 seconds, especially between 5 seconds and 60 seconds.

This radiation-curable primer composition P once applied onto a substrate can optionally be radiation-cured in an inert atmosphere instead of ambient air, i.e. oxygen-free, for example, in a nitrogen atmosphere. Oxygen is known to delay or inhibit certain radical polymerization processes, and it thus may be advantageous to prevent exposure to oxygen during curing of the applied primer composition P. For example, a sufficiently inert atmosphere can be achieved by covering a layer of the photoactive primer-coating with a plastic film which is substantially transparent to radiation and irradiating through that film in air. For example, such suitable ultraviolet radiation can be obtained from fluorescent-type lamps. There are also stabilizing additives for oxygen-sensitive radical- and/or radiation-curable compositions available and known to the skilled person in the field. These prevent interfering reactions with oxygen during the polymerization process and may be employed as well in the radiation-curable primer composition P.

The primer composition P may be applied in step a) of the method according to the invention in any suitable manner, such as by hand or automatically.

It is possible to apply primer composition P by using a foam, felt, cloth, tissue, brush, or other suitable application tool that ensures application of a sufficient amount in a controlled manner on substrate S1. This may be done by hand and automatically.

Furthermore, possible and preferred is a contactless application, which avoids contacting the substrate with the application tool and thus prevents any cross-contamination of several different substrates, e.g. by oil or other surface impurities, with the repeatedly used application tool as described above.

Thus, in a preferred embodiment of the method according to the invention, in step a), said liquid, radiation-curable primer composition P is applied with a contactless method, in particular by spraying or ink-jetting, most preferably by ink-jetting. Contactless methods may be performed by hand, but also and preferably automatically.

Thus, in a preferred embodiment of the method according to the invention, step a) is performed by an automatic application method, in particular by spraying or ink-jetting, most preferably by ink-jetting.

Automatic such contactless application in step a) of the method, especially by spraying or ink-jetting, is preferably done either by moving substrate S1 by a stationary applicator, e.g. by using a conveyor belt or robot, and/or by using a moveable applicator that may for example be a robot with attached applicator nozzle. It is also possible that both the applicator and the substrate S1 are in movement during application, e.g. by moving substrate S1 on a conveyor belt, while a robot applies primer composition P.

The method of the present invention has the advantage that primer composition P can be applied comparably fast, especially when performed automatically and in particular by a contactless method, especially by spraying or ink-jetting, most preferably by ink-jetting.

Due to the properties of primer composition P, in particular its low viscosity without containing solvents, a fast and contactless application without solvent flash-off delays is possible.

Thus, a nozzle spraying or ink-jetting primer composition P in step a) of the method can be moved with high speeds along the surface of substrate S1.

Preferably, in step a) of the method according to the present invention, the relative movement of said nozzle to said substrate S1 during a linear application is at least 0.5 m/s, preferably at least 0.6 m/s.

Non-linear application may be slower as two- or three-dimensional movement often cannot be performed in a sufficiently accurate way in such high speed.

Preferably, when step a) is performed by ink-jetting, the nozzle of the ink-jetting applicator is automatically moveable in three dimensions relative to substrate S1. This can be achieved either by moving the applicator nozzle using a suitable robot arm equipped with the nozzle or a setup as used in 3D printing devices, where the nozzle can be moved in three dimensions.

Such a configuration allows application of the primer composition P onto geometrically complex substrates S1 and/or surface portions on substrate S1 that are difficult to access by hand, such as within cavities.

In preferred embodiments of the present method, the application of primer composition P in step a) of the method is performed by ink-jetting.

Inkjet printing techniques have become very popular in commercial and consumer applications and thus highly advanced such devices have become widely used and very affordable. Inkjet printers operate by ejecting ink onto a receiving substrate in controlled patterns of closely spaced ink droplets. By selectively regulating the pattern of ink droplets, inkjet printers can produce a wide variety of printed features, including text, graphics, images, holograms and the like. Moreover, inkjet printers are capable of forming printed features on a wide variety of substrates, as well as three-dimensional objects in applications such as rapid prototyping.

These devices are not exclusively suitable for printing ink, but they can equally be used in the method according to the present invention to apply primer composition P in step a) of the method.

In principle all available common inkjet device systems, in particular their nozzles and possibly also the conveying mechanics for the liquids to be ink-jetted, are useable in step a) of the method according to the invention to ink-jet the primer composition P.

A suitable such automatic inkjet device that is useable in step a) of the method according to the invention for ink-jetting said liquid, radiation-curable primer composition P is, for example, disclosed in WO 2020/171714 A1. The application system disclosed in this publication is described as system for printing ink onto a three-dimensional print surface, but it can be used equally for applying a liquid, radiation-curable primer composition P according to the present invention in a fully automatic application process. Furthermore, the application system is suitable for substrates S1 having non-flat and/or sloped surfaces to be primer and/or several surfaces to be primed that require movement of the application device in three dimensions relative to substrate S1.

Especially for automatic application of primer composition P, it may be advantageous to additionally use an application result control mechanism, such as a camera, an infrared (IR) light source and IR detector, or a detector that detects indicator substances that may be added for this reason to primer composition P. Said indicator substances may be luminescent under certain radiation or otherwise produce a detectable response to an external trigger.

Such a control mechanism can be employed as process control measure in parallel to or after step a) to ensure a proper application of the primer on all required surfaces. Especially for substrate surfaces that are not readily accessible, e.g. within cavities, such a mechanism can be advantageous. Likewise, if the primer is colorless and/or applied in very low amounts, and thus not easily visible, a suitable control mechanism as described above may be advantageous.

Such a control mechanism can be performed fully automatically, by quantitatively or qualitatively measuring or detecting the applied primer composition and subsequent analysis by computer equipment. Qualitative measurements can for example evaluate whether all targeted surfaces or surface portions are properly covered by primer composition P. Quantitative measurements may be, for example, detection of indicator substances that have a concentration-dependent, measurable response, or by calibrated measurements of absorption of infrared (IR) radiation in the applied primer composition P, for example by attenuated total reflection infrared (ATR-IR) measurements, or Raman spectroscopy.

Quantitative measurements can be used to control a homogeneous primer application in terms of layer thickness or deposited amount. A further possibility to quantitatively measure the layer thickness of applied primer composition P are spectroscopic measurements involving suitable low energy radiation, e.g. IR radiation, transmitting the applied layer of primer composition P and reflecting off on the covered substrate below back through the primer layer and into a detector.

In preferred embodiments of the method according to the present invention, the said liquid, radiation-curable primer composition P is applied in step a) onto the surface of substrate S1 with an amount measured in volume of primer composition P per area of substrate S1 ranging from 1 cm³/m² to 10 cm³/m², preferably from 2 cm³/m² to 6 cm³/m², in particular from 2.5 cm³/m² to 5.5 cm³/m².

Such an amount ensures the deposition of a sufficiently primed substrate S1 surface for optimal adhesion of the adhesive A applied later thereon, but avoids an excessively thick primer layer that may weaken the adhesive bond later on and could even lead to primer failure and ultimately delamination. This is especially a problem in adhesive bonds that are exposed to strong forces, such as pull, compression, torsion, shearing, vibration, or thermally induced volume changes of substrate S1, where normally a high strength adhesive A with elastic properties is used. While the mechanical properties of such an adhesive are sufficient to endure these forces, a cured primer P normally lacks these elasticity and toughness capabilities. However, if properly applied in amounts as defined above, the resulting layer thickness is small enough that the forces acting on the adhesive bond can be fully absorbed by adhesive A.

One advantage of the method according to the present invention is that the primed substrate S1 after application and curing of the primer composition P may be stored for a long time up to several months without the primed surface losing its adhesion-promoting properties to a significant extent.

This is in contrast to common solvent- or water-based primers for example based on silane-, titanate-, zirconate- or polyurethane chemistries that often lose their adhesion-promoting effect after a few days.

Thus, it is possible and, in some embodiments, preferred to store the primed substrate S1 for a time of up to 6 months after step b) is performed in the inventive method.

In the same or other preferred embodiments, the primed substrate S1 is stored in step c) for at least one day and optionally transported to another location before step d) is performed.

This is for example advantageous if steps a) and b) of the method according to the invention are done at a different facility than the later steps involving adhesive A, and the primed substrate S1 obtained in step b) is stored and/or transported to the location where step d) is performed.

While the cured primer on substrate S1 is very stable towards chemical or physical degradation processes, it may be advantageous to protect it against deposition of dust, dirt, liquids, and other contaminants, especially if the storage time is comparably long. For this, a plastic foil or sheet is normally sufficient or simply a protecting package of any kind.

Another advantage of the method according to the present invention is that the primed substrate S1 after application and curing of the primer composition P may be immediately further processed by application of the curable adhesive composition A in step d).

Application of the primer composition P according the present invention requires no flash-off time or other waiting time other than the curing step c), which can be done typically within 1 and 120 seconds of irradiation. This enables extremely efficient and fast adhesive bonding processes that can furthermore be performed fully automatically.

Thus, in preferred embodiments of the method according to the present invention, after application of primer composition P in step a) and curing thereof in step b), application of the curable adhesive composition A in step d) is performed within less than 5 minutes after performing step a).

Adhesive Composition A

Step d) of the inventive method involves applying a curable adhesive composition A onto the cured primer composition P on substrate S1 obtained in step b).

Suitable are all curable adhesives commonly used in assembly adhesive bonding processes and structural bonding. The term “curable” requires that the adhesive cures irreversibly by chemical reactions and is not simply a thermoplastic melt composition that can be re-liquified simply by applying heat. Such adhesives are prone to creep when exposed to elevated temperatures.

It is possible to use curable sealants with adhesive properties as well in adhesive bonding applications where high bonding strength is not as important as high movement capability of the adhesive bond.

The curable adhesive composition A may take the form of a one-component or of a multi-component, especially two-component, composition.

In the present document, “one-component” refers to a composition in which all constituents of the composition are stored in a mixture in the same container and which may be curable with moisture, in particular moisture from air, or which may be curable by heat, radiation, or other applied curing triggers.

In the present document, “two-component” refers to a composition in which the constituents of the composition are present in two different components that are stored in separate containers. Only shortly before or during the application of the composition are the two components mixed with one another, whereupon the mixed composition cures, optionally under the action of moisture, heat. radiation, or other applied curing triggers.

Thus, in one or more preferred embodiments of the present invention, curable adhesive composition A is a one-component composition.

Thus, in other preferred embodiments of the present invention, curable adhesive composition A is a two-component composition.

Any second or optionally further components is/are mixed with the first component prior to or on application, especially by means of a static mixer or by means of a dynamic mixer.

The curable adhesive composition A is especially applied at ambient temperature, preferably within a temperature range between 0° C. and 45° C., especially 5° C. to 35° C., and cures under these conditions or under influence of heat, radiation, or other applied curing triggers.

For the intended application as adhesive A in step d) of the inventive method, the curable adhesive composition A preferably has a pasty consistency with structurally viscous properties. Such a pasty adhesive is especially applied to a primed substrate S1 out of standard cartridges that are operated manually, by means of compressed air or with a battery, or from a vat or hobbock by means of a delivery pump or an extruder, optionally by means of an application robot or another automated application device.

The curable adhesive composition A may also have liquid consistency at room temperature with self-leveling properties. It may be slightly thixotropic, such that the liquid adhesive is applicable to sloping to vertical surfaces without flowing away immediately. In this form, curable adhesive composition A is preferably applied by means of a roller or brush or by pouring-out and distribution by means, for example, of a roller, a scraper or a notched trowel. This application process can also be partially of fully automatic.

Preferably, the curable adhesive composition A applied in step d) is selected from the group consisting of moisture-curable compositions, heat-curable compositions, two-component curable compositions, curable hotmelt compositions, oxidation-curable compositions, and radiation-curable compositions.

Preferred moisture-curable adhesive compositions A that cure by moisture either from air or otherwise introduced include RTV-1 silicones, compositions based on silane-functional organic polymers also known as silane-terminated polymers (STP), one-component polyurethanes, two-component STP compositions, RTV-2 silicones, and boostered one-component polyurethanes with an admixed water-containing booster paste.

Preferred heat-curable adhesive compositions A that cure by applying heat include HC silicones, heat-curing polyurethanes or polyureas, reactive hotmelt compositions based on polyurethanes or STP, heat-curing and preferably toughened acrylate compositions, and single-component or two-component epoxy compositions.

Preferred two-component adhesive compositions A that cure after mixing two components with mutually reactive constituents include RTV-2 silicones, two-component polyurethanes or polyureas, two-component STP compositions, or two-component epoxy compositions.

Preferred further adhesive compositions A that have other curing mechanisms or a combination of curing mechanisms are oxidation-curable, radiation-curable, or radical-curable compositions such as preferably toughened acrylate compositions, one-component or two-component STP-epoxy hybrid compositions, STP-polyurethane hybrid compositions, STP-silicone hybrid compositions, and other hybrid compositions using the described or similar curing chemistries.

In preferred embodiments, the curable adhesive composition A is based on polyurethanes, silicones, silane-terminated polymers, epoxy resins, or acrylates.

Most preferred curable adhesive compositions A are two-component polyurethanes, moisture-curable polyurethanes that are optionally admixed with a water-containing second component, one-component or two-component STP compositions, one-component or two-component epoxy compositions, RTV-2 silicones, and heat-curing compositions based on polyurethanes or epoxy resins.

Particular preferred as curable adhesive compositions A are two-component polyurethanes (2C PUR) and one-component moisture-curable polyurethanes (1C PUR) that are optionally admixed with a water-containing second component. Polyurethane-based adhesives are highly versatile in terms of mechanical and adhesive performance and can easily be formulated to be suitable in automatic application processes.

Especially two-component polyurethanes are highly suitable for fast assembly processes that may be partially or fully automatic.

A particularly suitable such adhesive is disclosed in WO 2019/002538 A1. The two-component polyurethane adhesive taught in this publication can be adjusted in terms of curing speed and pot life and thus can be tailored fittingly in terms of curing behavior to assembly processes.

For automated application of curable adhesive composition A in step d), highly suitable such two-component polyurethane compositions are disclosed in WO 2021/001479 A1 and in particular in the publication WO 2021/001479 A1. Both these documents disclose two-component polyurethane compositions that are applied automatically, and WO 2021/001479 A1 teaches such a composition that additionally exhibit an adjustable, long pot life and fast curing suitable for high efficiency assembly processes, and a viscosity low enough for efficient mixing and conveying of the composition to an automatic application device. This makes it especially suitable for a fully automatic method according to the present invention.

In preferred embodiments of the method according to the invention, the primer application in step a) is performed at least partially automatically, preferably fully automatically and/or involving industrial robots, especially by a contactless method, in particular spraying or ink-jetting, most preferably ink-jetting.

In some embodiments, this step is accompanied or followed by a control mechanism as detailed further above.

In the same or different preferred embodiments of the method according to the invention, step a) and at least one of steps b), c), d) and/or e) of the method are performed at least partially and in particular fully automatically, especially by involving industrial robots and/or conveyor belts and/or other automatic transportation or application devices.

In the same or different preferred embodiments of the method according to the invention, at least step a) and step b) and preferably step d) and/or e) of the method are performed at least partially and in particular fully automatically, especially by involving industrial robots and/or conveyor belts and/or other automatic transportation or application devices.

Step e) of the method according to the invention is joining substrate S2 to the adhesive composition A on substrate S1 such that an adhesive bond is formed between substrate S1 and substrate S2, wherein the surface of substrate S2 to be adhesively bonded is optionally pre-treated to improve adhesion before step e) is performed.

Substrate S2, depending on the substrate surface material and used adhesive A, is preferably pre-treated to improve adhesion of adhesion composition A thereon.

Any suitable pre-treatment may be used without limitation. If the pre-treatment step of substrate S2 is done at the same place as the method of this invention and if substrate S2 is suitable for this pre-treatment method, it is advantageous to use the same method as for substrate S1.

In preferred embodiments of the method according to the invention, said substrate S2 when used in step e) of the method, was pre-treated prior to step e) by using a primer, in particular by employing the same method as substrate S1.

Step f) of the method involving the curing of the curable adhesive composition A should be done suitably for the curing mechanism of adhesive composition A. This means that the external trigger to induce curing is applied actively, e.g. by heating or irradiation, or passively, e.g. by exposure to moisture or oxygen from air or simply waiting in the case of a mixed reactive two-component adhesive composition.

This step may also be performed automatically, especially in case of heat- or radiation-curing compositions, where the curing trigger may be applied automatically. Compositions that do not require additional triggers, such as mixed reactive two-component adhesive compositions, are of course also compatible with an automated application process.

The method according to the present invention is particularly suitable, for industrial assembly processes, in particular automotive assembly and assembly of machinery such as white goods and assembly of construction parts, such as fenestration frames, and is preferably employed in such processes.

In preferred embodiments of the method according to the invention, the surface of said substrate S1 and/or said substrate S2 whereon said liquid, radiation-curable primer composition P and/or said curable adhesive A are applied is made of metal, oxidized metal, powder- or polymer-coated metal, plastics, glass, ceramics, or fiber-reinforced resins.

### EXAMPLES

Adduced hereinafter are working examples which are intended to elucidate the invention described in detail. It will be appreciated that the invention is not restricted to these described working examples. “Standard climatic conditions” refer to a temperature of 23±1° C. and a relative air humidity of 50±5%.

Used Primer Compositions

The following primer compositions were used for the test protocol.

Primer P-1 (primer composition P according to invention) Primer composition P-1 was prepared by mixing all ingredients shown in Table 1 in their respective amounts at room temperature in a Speedmixer® (Hauschild, Germany) until a homogeneous mixture was obtained.

TABLE 1
Raw materials and amounts (in % by weight based on the
total composition) used in primer composition P-1.

| Raw | % by | | | |
|---|---|---|---|---|
| material | weight | Chemical Name | Function | Supplier |
| Miramer | 45 | Tridecyl acrylate | Radiation- | Miwon |
| M124 | | | polymerizable | Speciality |
| | | | monomer | Chemical Co. |
| Ebercryl | 30 | difunctional aliphatic | Radiation-curable | Allnex |
| 8810 | | urethane acrylate | polymer | |
| Omnirad | 2 | Bis(2,4,6- | Photoinitiator | IGM Resins |
| 2022 | | trimethylbenzoyl)- | | |
| | | phenyl-phosphine oxide | | |
| SR-399 | 5 | pentaerythritol | Multifunctional | Sartomer |
| | | triacrylate | radiation- | (Arkema) |
| | | | polymerizable | |
| | | | monomer | |
| | | | (crosslinker) | |
| LED 03 | 15 | Amine modified | Amine | Allnex |
| | | polyester acrylate | photosynergist | |
| Dyamlink | 2 | Zinc-di-methacrylate | Adhesion-promoting | Sartomer |
| 708 | | | radiation- | (Arkema) |
| | | | polymerizable | |
| | | | monomer | |
| Silquest | 1 | 3-Mercaptopropyl | Adhesion-promoting | Momentive |
| A189 | | trimethoxysilane | radiation- | Performance |
| | | | polymerizable | Materials |
| | | | monomer | |

Primer P-2 (Primer Composition not According to Invention)

As primer composition P-2, a commercially available 2-component water-based primer “SikaPrimer®-220 Hydro” (available from Sika) was used. This primer composition is based on organosilanes dispersed/dissolved in water and especially suitable for glass and plastic substrates and in connection with, for example, 1C polyurethane Sikaflex® adhesives. Application was done according to the technical datasheet guidelines, involving a flash-off time of 30 min until the primer film after application was fully dry.

Primer P-3 (Primer Composition not According to Invention)

As primer composition P-3, a commercially available single-component solvent-based primer “SikaPrimer®-206 G&P” (available from Sika) was used. This primer composition is based on polyisocyanates and organosilanes dispersed/dissolved in solvent and especially suitable for glass and plastic substrates and in connection with, for example, 1C polyurethane Sikaflex® adhesives. Application was done according to the technical datasheet guidelines, involving a flash-off time of 30 min until the primer film after application was fully dry.

Test Protocol

The primer P-1 was applied with a foam onto a polycarbonate adhesion test specimen plate (Makrolon® Makroform 099: clear, non-coated polycarbonate (Covestro), available from Rocholl, Germany, having the dimensions 300 mm×200 mm×2 mm) and then cured under UV light (wavelength spectrum 365 nm-415 nm) during 90 s by means of a hand cure UV-LED lamp.

For primers P-2 and P-3, the respective application guidelines were followed by applying the respective primers onto identical substrates using a foam and waiting for 30 min, until the required flash-off times (and for primer P-3, the time required for the primer film to sufficiently cure by moisture) had passed.

Afterwards, beads of single-component (1C), moisture-curable polyurethane adhesive Sikaflex®-250 (elastic adhesive for e.g. glass, ceramic and coated metal substrates, optimized for automotive OEM customers) were applied onto the cured primer layer. For the tests without primer, the adhesive was applied directly onto the test specimen substrate surface.

The adhesives were cured for 7 days under standard climatic conditions. Afterwards, the adhesives were exposed to a peeling force by bead adhesion tests. The fracture modes of the peeled beads were evaluated. The resulting adhesion fracture patterns are presented in Table 2. “100% AF” means an undesirable 100% adhesive failure, while “100% CF” means an optimal 100% cohesive failure pattern.

Test Results

The test results are presented in Table 2.

TABLE 2
Adhesion tests and waiting time between application
of the primer and application of the adhesive.

| Primer composition P | without | P-1 | P-2 (Ref.) | P-3 (Ref.) |
|---|---|---|---|---|
| VOC content | 0% | 0% | 0% | >80% |
| Substrate S1 | Polycarbonate (Makrolon ®, Rocholl) | | | |
| Adhesive composition A | Moisture-curable 1C PUR (Sikaflex ®-250) | | | |
| Waiting time between | — | 90 s | 30 min | 30 min |
| primer application and | | | | |
| adhesive application (e.g. | | | | |
| flash-off time) | | | | |
| Fracture mode | 100% AF | 100% CF | 100% CF | 100% CF |

Table 2 shows that the method according to the present invention, using primer P-1, makes it possible to apply the adhesive within much shorter time after application of the primer, compared to conventional primers P-2 and P-3. At the same time, identically optimal adhesion performance is obtained.

1. A method for adhesively bonding two substrates S1 and S2, comprising the steps:
a) applying a liquid, radiation-curable primer composition P onto the surface of substrate S1;
b) curing the liquid, radiation-curable primer composition P by applying radiation with a suitable wavelength, intensity and temporal exposure such that the radiation-curable primer composition P is cured into a solidified, coherent or interrupted layer adhering to the surface of substrate S1;
c) optionally storing the primed substrate S1 for a time of up to 6 months;
d) applying a curable adhesive composition A onto the cured primer composition P on substrate S1;
e) joining substrate S2 to the adhesive composition A on substrate S1 such that an adhesive bond is formed between substrate S1 and substrate S2, wherein the surface of substrate S2 to be adhesively bonded is optionally pre-treated to improve adhesion before step e) is performed;
f) curing the curable adhesive composition A;
wherein
the liquid, radiation-curable primer composition P comprises:
at least one radiation-polymerizable monomer,
at least one photosensitizer, photosynergist, photoinitiator, and/or catalyst suitable to induce or accelerate radiation curing of the radiation-polymerizable monomer;
optionally at least one radiation-curable polymer;
optionally further additives selected from the group consisting of pigments, fillers, rheology modifiers, stabilizers, tougheners, and surfactants;
wherein the radiation-curable primer composition P contains less than 5% by weight of solvents, in relation to the whole primer composition P.

2. The method according to claim 1, wherein in step a), the liquid, radiation-curable primer composition P is applied with a contactless method.

3. The method according to claim 1, wherein step a) is performed by an automatic application method.

4. The method according to claim 3, wherein step a) is performed by ink-jetting and the nozzle of the ink-jetting applicator is automatically moveable in three dimensions relative to substrate S1.

5. The method according to claim 3, wherein the relative movement of the nozzle to the substrate S1 during a linear application is at least 0.5 m/s.

6. The method according to claim 1, wherein the substrate S2 was pre-treated using a primer.

7. The method according to claim 1, wherein step a) and at least one of steps b), c) and/or d) are performed automatically.

8. The method according to claim 1, wherein the primed substrate S1 is stored in step c) for at least one day and optionally transported to another location before step d) is performed.

9. The method according to claim 1, wherein, after application of primer composition P in step a) and curing thereof in step b), application of the curable adhesive composition A in step d) is performed within less than 5 minutes after performing step a).

10. The method according to claim 1, wherein the curable adhesive composition A applied in step d) is selected from the group consisting of moisture-curable compositions, heat-curable compositions, two-component curable compositions, curable hotmelt compositions, oxidation-curable compositions, and radiation-curable compositions.

11. The method according to claim 10, wherein the curable adhesive composition A is based on polyurethanes, silicones, silane-terminated polymers, epoxy resins, or acrylates.

12. The method according to claim 1, wherein the radiation used in step b) is selected from the group consisting of ultraviolet light, electron beams, gamma rays and X-rays.

13. The method according to claim 12, wherein the radiation is ultraviolet light having an effective ultraviolet wavelength from 100 nm to 500 nm, or wherein the radiation is an electron beam applied in an amount ranging from 10′000 Gy to 300′000 Gy.

14. The method according to claim 13, wherein the radiation is ultraviolet light and the irradiation time employed to cure the liquid, radiation-curable primer composition P ranges between 1 second and 120 seconds.

15. The method according to claim 1, wherein the liquid, radiation-curable primer composition P is applied in step a) onto the surface of substrate S1 with an amount measured in volume of primer composition P per area of substrate S1 ranging from 2 cm³/m² to 6 cm³/m².

16. The method according to claim 1, wherein the radiation-polymerizable monomer comprised in the liquid, radiation-curable primer composition P consists of (meth)acrylate monomers in an amount of at least 50% by weight, in relation to the whole primer composition P, and optionally thiol-functional adhesion-promoting monomers.

17. The method according to claim 16, wherein the liquid, radiation-curable primer composition P consists of (meth)acrylate monomers and optionally thiol-functional adhesion-promoting monomers, and optionally at least one radiation-curable polymer, and the at least one photosensitizer, photosynergist, photoinitiator, and/or catalyst.

18. The method according to claim 1, wherein the method is employed in industrial assembly processes.
